(19) United States
(12) Patent Application Publication
(10) Pub. No.: US 2014/0210404 A1
(43) Pub. Date: Jul. 31, 2014

(54) APPARATUS FOR BOTH INDUCTIVE COUPLED POWER TRANSFERRING AND ELECTRICAL-FIELD COUPLED POWER TRANSFERRING

(71) Applicant: ESPOWER ELECTRONICS INC., New Taipei City (TW)

(72) Inventor: CHING-CHI LIN, KEELUNG CITY (TW)

(73) Assignee: ESPOWER ELECTRONICS INC., NEW TAIPEI CITY (TW)

(21) Appl. No.: 13/751,091

(22) Filed: Jan. 27, 2013

(51) Int. Cl. H02J 7/00

(52) U.S. Cl. CPC H02J 7/0004
USPC 320/108

(57) ABSTRACT

An apparatus for both inductive coupled power transferring and electrical-field coupled power transferring is disclosed. The apparatus includes a power converter, a control circuit, a wireless communication receiving circuit, and a metal plate. The power converter receives input voltage and converts the input voltage into specific voltage. The control circuit controls the power converter. The wireless communication receiving circuit receives a power identification signal which is power requirement information coming from a first or second external device. The metal plate is coupled to the power converter. When inductive coupled power transfer mode is executing, the control circuit controls the power converter for outputting magnetic-field electricity to charge the first external device. When electrical-field coupled power transfer mode is executing, the control circuit controls the power converter for outputting high frequency and high voltage power to the metal plate, to output electrical-field electricity and charge the second external device.

### BACKGROUND OF THE INVENTION

1. Field of the Invention

The present invention relates to a wireless charging technique; in particular, to an apparatus for both inductive coupled power transferring and electrical-field coupled power transferring.

2. Description of Related Art

Along with the lightening and thinning of the electric devices, the users are used to carrying those electric devices. The common electric devices such as the cell phones, the personal digital assistances (PDA), the notebook computers, the tablet computers, the digital cameras, and the digital camcorders, etc., are widely used by the people, and become the necessities in the information life.

For reducing the troublesome of wired charging, the concepts for providing wireless power system by using electromagnetic induction theorems have been addressed many years ago. Because of the actual restrictions of the conventional induction techniques, the conventional wireless charging system faces considerable restrictions. For example, for providing reasonable and effective operations, the conventional wireless charging system needs to have close and precise alignment between the primary coil and the secondary coil. In addition, a highly coordinated tuning between the electric device in the inductive power supply and the electric device in the remote device is required. Because different remote devices may need very different number of powers, the problems can be much more complicated.

The applications of the present wireless charging are only used in one-to-one manners. In other words, a single mobile device needs to be corresponding to an assigned wireless charging device. However, when the products are different, the wireless charging device is incompatible. Thus, a wireless power supply system which is compatible with several products is disclosed in the disclosure.

### SUMMARY OF THE INVENTION

The disclosure discloses an apparatus for both inductive coupled power transferring and electrical-field coupled power transferring. The apparatus can transmit electricity to the external devices by using magnetic-field when under an inductive coupled power transfer (ICPT) mode, and can transmit electricity to the external devices by using electrical-field when under an electrical-field coupled power transfer (ECPT) mode.

For achieving the aforementioned objectives and other objectives, the disclosure provides an apparatus for both inductive coupled power transferring and electrical-field coupled power transferring. The apparatus is for outputting a magnetic-field electricity to charge a first external device when under the ICPT mode, and for outputting an electrical-field electricity to charge a second external device when under the ECPT mode. The apparatus includes a power converter, a control circuit, a wireless communication receiving circuit, and a metal plate. The power converter receives an input voltage and converts the input voltage into a specific voltage. The control circuit is for controlling the power converter. The wireless communication receiving circuit is for receiving a power identification signal which comes from power requirement information of the first or the second external device. The metal plate is coupled to the power converter.

When the wireless communication receiving circuit receives the power identification signal of the first external device, the apparatus for both inductive coupled power transferring and the electrical-field coupled power transferring executes the ICPT mode, and the control circuit controls the power converter to output the magnetic-field electricity for charging the first external device. When the wireless communication receiving circuit receives the power identification signal of the second external device, the apparatus executes the ECPT mode, and the control circuit controls the power converter to output a high frequency and high voltage power to the metal plate, for outputting the electrical-field electricity to charge the second external device.

The disclosure is for integrating the circuits of both the ICPT and the ECPT, which makes the wireless charger be able to support the two modes of the wireless electricity transfer modes. Moreover, the integrated ICPT and ECPT circuits can use less components for achieving the same functionalities.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a circuit block diagram of an apparatus for both inductive coupled power transferring and electrical-field coupled power transferring according to a first embodiment of the disclosure;

FIG. 2 shows a top view diagram of a metal plate of an apparatus for both inductive coupled power transferring and electrical-field coupled power transferring according to a second embodiment of the disclosure;

FIG. 3 shows a circuit block diagram of an apparatus for both inductive coupled power transferring and electrical-field coupled power transferring which is applied in the inductive coupled power transfer (ICPT) according to a third embodiment of the disclosure;

FIG. 4 shows a circuit block diagram of an apparatus for both inductive coupled power transferring and electrical-field coupled power transferring which is applied in the electrical-field coupled power transfer (ECPT) according to a fourth embodiment of the disclosure; and

FIG. 5 shows a top view diagram of a metal plate of an apparatus for both inductive coupled power transferring and electrical-field coupled power transferring according to a fifth embodiment of the disclosure.

### DETAILED DESCRIPTION OF THE PREFERRED EMBODIMENTS

In the following descriptions, the embodiments of the disclosure are described along with several figures, and the same symbol number in the figures can be used for representing the similar components.

### First Embodiment

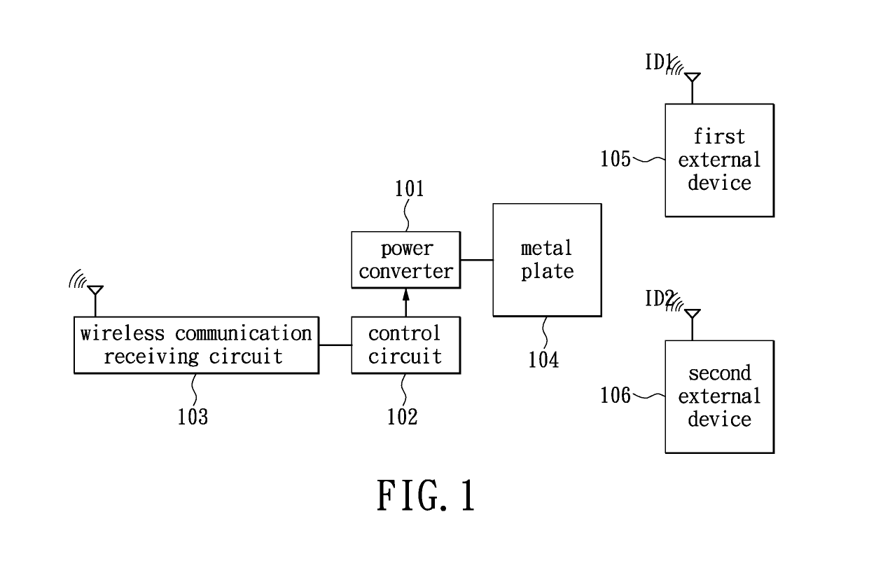

FIG. 1 shows a circuit block diagram of an apparatus for both inductive coupled power transferring and electrical-field coupled power transferring according to a first embodiment of the disclosure. Please refer to FIG. 1, the apparatus includes a power converter 101, a control circuit 102, a wireless communication receiving circuit 103, and a metal plate 104. For describing the spirit of the disclosure, the circuit diagram in this embodiment further shows a first external device 105 and a second external device 106. The power converter 101 receives an input voltage VIN, and converts the input voltage VIN into a specific voltage VOUT. The control circuit 102 is for controlling the power converter 101. The wireless communication receiving circuit 103 is coupled to the control circuit 102, for receiving a first power identification signal ID1 from the first external device 105 or a second power identification signal ID2 from the second external device 106. The first and second power identification signals ID1 and ID2 respectively include the power requirement information of the first external device 105 and the power requirement information of the second external device 106. The metal plate 104 is coupled to the power converter 101.

Supposing that the first external device 105 uses the ICPT techniques for charging (that is, the magnetic-field charging), and the second external device 106 uses the ECPT techniques for charging (that is, the electrical-field charging).

Supposing that the first external device 105 is disposed at the apparatus for both inductive coupled power transferring and electrical-field coupled power transferring, at the moment, the power identification signal ID1 emitted by the first external device 105 can be received by the wireless communication receiving circuit 103, then the wireless communication receiving circuit 103 notices the control circuit 102 for entering the ICPT mode. The control circuit 102 then controls the power converter 101 for outputting the magnetic-field electricity to charge the first external device 105.

Similarly, supposing that the second external device 106 is disposed at the apparatus for both inductive coupled power transferring and electrical-field coupled power transferring, at the moment, the power identification signal ID2 emitted by the second external device 106 can be received by the wireless communication receiving circuit 103, then the wireless communication receiving circuit 103 notices the control circuit 102 for entering the ECPT mode. The control circuit 102 then controls the power converter 101 for outputting a high frequency and high voltage power HV to the metal plate 104. By using the metal plate 104, the electrical-field electricity can be transferred to the second external device 106 for charging the second external device 106.

Generally, the ICPT mode mainly uses the coils for outputting magnetic-field, thus the first external device 105 must have a coil for receiving magnetic-field. The ECPT mode uses the plate for outputting the electrical-field, thus the second external device 106 must have a metal plate. However, the ECPT mode requires the power converter to increase the voltage to about 1.5 KV, thus the controls of the two modes are totally different.

For increasing the integration of the circuits, the following descriptions show an embodiment which integrates the plate and the coil, to serve as a reference for the one skilled in the art.

### Second Embodiment

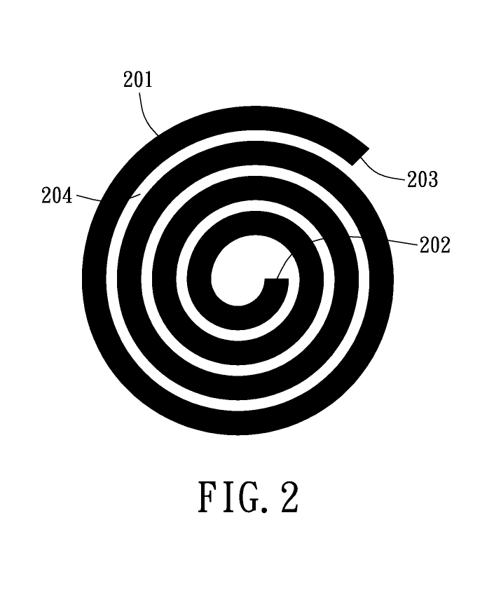

FIG. 2 shows a top view diagram of a metal plate of an apparatus for both inductive coupled power transferring and electrical-field coupled power transferring according to a second embodiment of the disclosure. Please refer to FIG. 2, the metal plate of the apparatus includes a plate coil 201 which is winded at a plane surface, and the width of the winding is L. The winding of the plate coil 201 is winded from the inner first terminal 202 to the outer second terminal 203. We can see from this top view that the structure of the plate coil 201 is similar to a plate, and the plate coil 201 can be seen as a remaining plate which is formed by etching off the interval part 204 of a metal plate.

### Third Embodiment

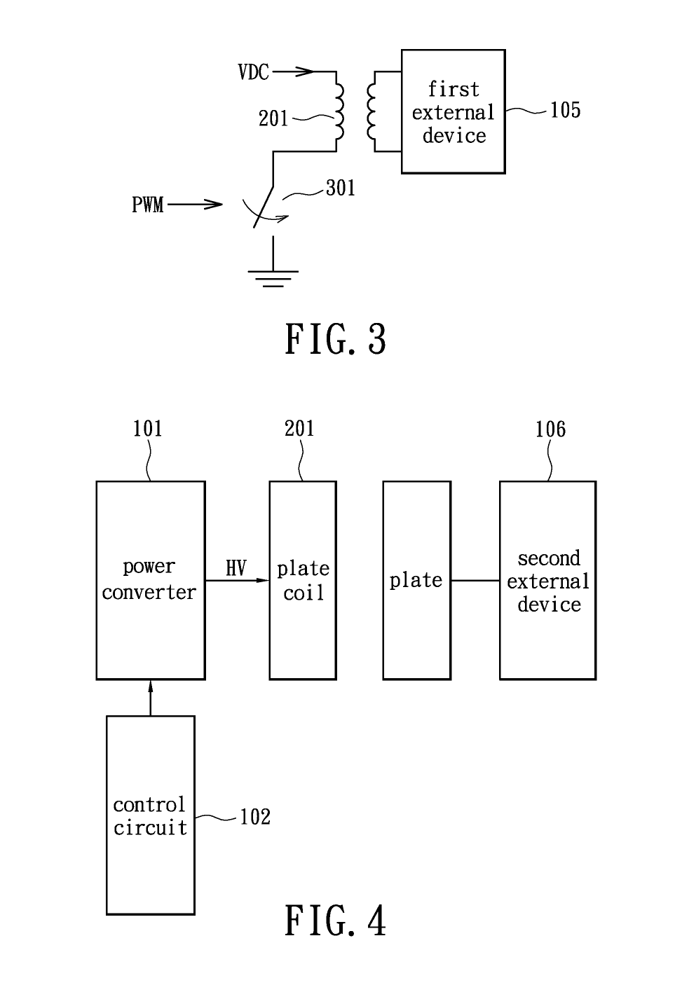

FIG. 3 shows a circuit block diagram of an apparatus for both inductive coupled power transferring and electrical-field coupled power transferring which is used in ICPT mode according to a third embodiment of the disclosure. Please refer to FIG. 3, when the coil for both inductive coupled power transferring and electrical-field coupled power transferring in FIG. 2 is used under ICPT situation, the plate coil 201 is used as a coil, thus in the aspect of circuit structure, the first terminal of the coil is used for inputting a rectified voltage VDC (such as the voltage of the 110V main electricity in Taiwan after doing bridge rectification). The second terminal of the coil is coupled to the switch 301 of the power converter 101. The switch 301 receives the pulse width modulation signal PWM outputted by the control circuit 102. Thus, by controlling the turn-on and turn-off of the switch 301 of the power converter 101, the control circuit 102 may be able to control the magnetic-field outputted by the plate coil 201, for transferring electricity to the first external device 105.

### Fourth Embodiment

FIG. 4 shows a circuit block diagram of an apparatus for both inductive coupled power transferring and electrical-field coupled power transferring which is used in ECPT mode according to a fourth embodiment of the disclosure. Please refer to FIG. 4, when the coil for both inductive coupled power transferring and electrical-field coupled power transferring in FIG. 2 is used under the situation of ECPT, the plate coil 201 is used as a plate. At the moment, the second terminal of the plate coil 201 is connecting with nothing, that is, the second terminal is isolated with the ground. The control circuit 102 outputs the electrical-field electricity for charging the second external device 106 by controlling the frequency and voltage of the voltage HV outputted by the power converter 101.

### Fifth Embodiment

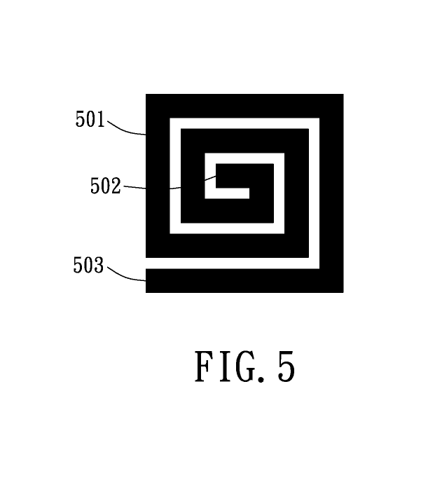

FIG. 5 shows a top view diagram of a metal plate of an apparatus for both inductive coupled power transferring and electrical-field coupled power transferring according to a fifth embodiment of the disclosure. Please refer to FIG. 5, although the above embodiments implement the coil in circular shape, the embodiment herein implements the coil in rectangular shape. In similar manners, the winding of the plate coil 501 is disposed at a plane surface, and the width of the winding is L. The plate coil 501 is winded from the inner first terminal 502 to the outer second terminal 503, and is winded in rectangular shape. The advantage of this winding is that the mobile devices are usually designed to be structured in rectangular shape, thus if the winding in the disclosure is in rectangular shape, it may match the products of the external devices and increase the coupling area A.

Although the aforementioned embodiments only show the circle winding and the rectangle winding, the one skilled in the art should know that the shape of the winding can be changed according to different designs, such as triangle, trapezoid, or oval, and the scope of the disclosure is not limited thereby.

On the basis of the above, the disclosure integrates the circuits of the ICPT and the ECPT, for making the wireless charger to support both modes of wireless electricity transfer. Moreover, the integrated circuits may be able to use less components for achieving the same functionalities of both modes.

In the embodiments of the disclosure, the shape of the electrical line of the coil is changed to plate shape, and the coil is winded at a plane surface. Thus, when under the ICPT mode, the first terminal of the plate coil is inputted a first external voltage, and by using the switching operations at the second terminal of the plate coil, the plate coil may be able to output the magnetic-field electricity for charging the first external device. When under the ECPT mode, the first terminal of the plate coil is inputted a second external voltage and the second terminal of the plate coil is opened. By controlling the frequency and voltage of the second external voltage, the plate coil may be able to output the electrical-field electricity for charging the second external device.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. An apparatus for both inductive coupled power transferring and electrical-field coupled power transferring, for outputting a magnetic-field electricity to charge a first external device when under an inductive coupled power transfer mode, and for outputting an electrical-field electricity to charge a second external device when under an electrical-field coupled power transfer mode, the apparatus comprising:
a power converter, for receiving an input voltage and converting the input voltage into a specific voltage;
a control circuit, for controlling the power converter;
a wireless communication receiving circuit, for receiving a first power identification signal and/or a second power identification signal, wherein the first power identification signal includes power requirement information of the first external device, and the second power identification signal includes power requirement information of the second external device; and
a metal plate, coupled to the power converter;
wherein when the wireless communication receiving circuit receives the first power identification signal of the first external device, the apparatus for both inductive coupled power transferring and electrical-field coupled power transferring executes the inductive coupled power transfer mode, and the control circuit controls the power converter for outputting the magnetic-field electricity to charge the first external device;
wherein when the wireless communication receiving circuit receives the second power identification signal of the second external device, the apparatus for both inductive coupled power transferring and electrical-field coupled power transferring executes the electrical-field coupled power transfer mode, and the control circuit controls the power converter for outputting a high frequency and high voltage power to the metal plate, in order to output the electrical-field electricity for charging the second external device.

2. The apparatus for both inductive coupled power transferring and electrical-field coupled power transferring according to claim 1, wherein the metal plate is:
a plate coil, wherein a wire part of the plate coil includes an assigned width and is platy, and the plate coil is winded at a plane surface which is parallel with a plate of the plate coil;
wherein when under the inductive coupled power transfer mode, the power converter input a first external voltage into a first terminal of the plate coil; and
a switch of the power converter is coupled to a second terminal of the plate coil, and the power converter outputs the magnetic-field electricity for charging the first external device by a switching operation of the second terminal of the plate coil;
wherein when under the electrical-field coupled power transfer mode, the power converter input a second external voltage into the first terminal of the plate coil, and controls the second terminal of the plate coil to be opened, for outputting the electrical-field electricity to charge the second external device by controlling frequency and voltage magnitude of the second external voltage, wherein the second external voltage is the high frequency and high voltage power.

3. The apparatus for both inductive coupled power transferring and electrical-field coupled power transferring according to claim 2, wherein the plate coil includes a circle center, and the plate coil is winded in a concentric circle and radial manner according to the circle center.

4. The apparatus for both inductive coupled power transferring and electrical-field coupled power transferring according to claim 3, wherein a metal plane part of the plate coil occupies over 80% area of a circle area formed from the circle center to a radius of the plate coil.

5. The apparatus for both inductive coupled power transferring and electrical-field coupled power transferring according to claim 2, wherein the plate coil includes a central point, and the plate coil is winded in a rectangular and radial manner according to the central point.

6. The apparatus for both inductive coupled power transferring and electrical-field coupled power transferring according to claim 5, wherein a metal plane part of the plate coil occupies over 80% area of a rectangular area surrounded by a surrounding of the plate coil.
